(19) United States
(12) Patent Application Publication
(10) Pub. No.: US 2020/0124456 A1
(43) Pub. Date: Apr. 23, 2020

(54) METHOD OF INSPECTING AND FLOW RATE CONTROLLER

(71) Applicant: Tokyo Electron Limited, Tokyo (JP)

(72) Inventors: Atsushi SAWACHI, Kurokawa-gun (JP); Norihiko AMIKURA, Kurokawa-gun (JP)

(73) Assignee: Tokyo Electron Limited, Tokyo (JP)

(21) Appl. No.: 16/656,977

(22) Filed: Oct. 18, 2019

(30) Foreign Application Priority Data
Oct. 22, 2018 (JP) 2018-198247

(51) Int. Cl. G01F 7/00; G05D 7/06; G05D 11/13

(52) U.S. Cl. CPC G01F 7/005; G05D 11/132; G05D 7/0635

(57) ABSTRACT

The method of inspecting a flow rate controller for controlling a flow rate of a fluid, the flow rate controller including a first pressure detector for detecting a first pressure that is a pressure of the fluid, and a diaphragm valve provided downstream of the first pressure detector and having a diaphragm and a piezoelectric element for driving the diaphragm, the method including: acquiring reference data including the first pressure and a control value of the piezoelectric element with respect to a set flow rate of the fluid; measuring target data including the first pressure and the control value of the piezoelectric element with respect to the set flow rate of the fluid after execution of the acquiring; and determining whether or not there is a problem in the diaphragm valve, by comparing the reference data with the target data.

### CROSS-REFERENCE TO RELATED APPLICATIONS

This application is based on and claims the benefit of priority from Japanese Patent Application No. 2018-198247 filed on Oct. 22, 2018, and the entire contents of which are incorporated herein by reference.

### TECHNICAL FIELD

Exemplary embodiments of the present disclosure relate to an inspection method and a flow rate controller.

### BACKGROUND

Japanese Unexamined Patent Publication No. H8-338546 discloses a pressure-type flow rate control device for performing flow rate control. This device includes an orifice and a control valve provided upstream of the orifice. The control valve adjusts pressure upstream of the orifice and controls a flow rate downstream of the orifice to reach a set value. The control valve has a diaphragm, a piezoelectric element pressing the diaphragm downward, and a valve seat. The diaphragm is always pressed downward through the piezoelectric element and is in contact with the valve seat. If the pressing is released, the diaphragm returns upward with an elastic force. The diaphragm is separated from the valve seat, whereby the control valve enters an opened state.

### SUMMARY

In an aspect of the present disclosure, an inspection method is provided. The inspection method is an inspection method for a flow rate controller for controlling a flow rate of a fluid, the flow rate controller including a first pressure detector for detecting a first pressure that is a pressure of the fluid, and a diaphragm valve provided downstream of the first pressure detector and having a diaphragm and a piezoelectric element for driving the diaphragm, the inspection method including: acquiring reference data including the first pressure and a control value of the piezoelectric element with respect to a set flow rate of the fluid; measuring target data including the first pressure and the control value of the piezoelectric element with respect to the set flow rate of the fluid after execution of the acquiring; and determining whether or not there is a problem in the diaphragm valve, by comparing the reference data with the target data.

The foregoing summary is illustrative only and is not intended to be in any way limiting. In addition to the illustrative aspects, exemplary embodiments, and features described above, further aspects, exemplary embodiments, and features will become apparent by reference to the drawings and the following detailed description.

### BRIEF DESCRIPTION OF THE DRAWINGS

FIG. 1 is a flowchart illustrating an example of a reference acquisition step of an inspection method for a flow rate controller according to an embodiment.

FIG. 2 is a flowchart illustrating an example of a target measurement step and a determination step of the inspection method for the flow rate controller according to the embodiment.

FIG. 3 is a schematic diagram illustrating an example of a fluid supply system which includes the flow rate controller according to the embodiment.

FIG. 4 is a diagram illustrating an example of a configuration of a diaphragm valve.

FIG. 5 is a block diagram illustrating an example of a function of the inspection method for the flow rate controller according to the embodiment.

FIG. 6 is a graph illustrating an example of the relationship between reference data and target data in the determination step of the inspection method for the flow rate controller according to the embodiment.

### DETAILED DESCRIPTION

Hereinafter, various exemplary embodiments will be described.

The exemplary embodiments described in the detailed description, drawing, and claims are not meant to be limiting. Other exemplary embodiments may be utilized, and other changes may be made, without departing from the spirit or scope of the subject matter presented here.

In a control valve of a flow rate controller, there is a concern that the flow rate of a fluid may deviate from a set value according to a use period, a use frequency, a use environment, or the like. For this reason, it is necessary to inspect whether or not the control valve can control the flow rate, based on the set value. However, the pressure-type flow rate control device described in Japanese Unexamined Patent Publication No. H8-338546 does not have a function capable of inspecting the control of the control valve. Further, in the control valve, a variation width of a piezoelectric element itself and a variation width of a diaphragm connected to the piezoelectric element are very small, and therefore, an individual difference in the displacement amount of the piezoelectric element itself and an individual difference in the displacement amount of the diaphragm occur. There is an individual difference between the flow rate controllers, and therefore, it is difficult to provide an inspection index applicable to all the flow rate controllers.

The present disclosure provides a flow rate controller inspection method and a flow rate controller, in which it is possible to inspect a flow rate control function regardless of an individual difference of the flow rate controller.

In an aspect of the present disclosure, an inspection method is provided. The inspection method is an inspection method for a flow rate controller for controlling a flow rate of a fluid, the flow rate controller including a first pressure detector for detecting a first pressure that is a pressure of the fluid, and a diaphragm valve provided downstream of the first pressure detector and having a diaphragm and a piezoelectric element for driving the diaphragm, the inspection method including: a reference acquisition step of acquiring reference data including the first pressure and a control value of the piezoelectric element with respect to a set flow rate of the fluid; a target measurement step of measuring target data including the first pressure and the control value of the piezoelectric element with respect to the set flow rate of the fluid after execution of the reference acquisition step; and a determination step of determining whether or not there is a problem in the diaphragm valve, by comparing the reference data with the target data.

According to this inspection method, the fluid having the set flow rate flows through a flow path passing through the flow rate controller in the order to the first pressure detector and the diaphragm valve. The first pressure of the fluid is measured by the first pressure detector. In the reference acquisition step, the reference data including the first pressure and the control value of the piezoelectric element with respect to the set flow rate of the fluid is acquired. In the acquisition of the reference data, the reference data may be acquired by reading the reference data already recorded from an external recording device, or may be acquired by measuring reference data. In the target acquisition step, the target data including the first pressure and the control value of the piezoelectric element with respect to the set flow rate of the fluid is measured. In the determination step, the reference data is compared with the target data. Since the old and new first pressures acquired under the common setting condition in the same flow rate controller can be compared with the control value of the piezoelectric element, it is possible to perform the inspection regardless of the individual difference of the flow rate controller. By this inspection, it is possible to always monitor the abnormality or specular change of the diaphragm valve which occurs according to a use period, a use frequency, a use environment, or the like, at the time of maintenance. Accordingly, in this inspection method for the flow rate controller, it is possible to inspect the control function of the flow rate controller regardless of the individual difference of the flow rate controller.

In an embodiment, in the inspection method, the reference acquisition step may include a reference measurement step of measuring the reference data, and a reference recording step of recording the reference data. In this case, the reference data in the reference acquisition step is acquired by being measured by the reference measurement step and recorded by the reference recording step. Even in a case where there is no reference data already recorded, by providing the reference measurement step and the reference recording step, it is possible to perform a comparison by using the reference data in the determination step.

In an embodiment, in the inspection method, the reference acquisition step may be a step of closing a valve provided between a supply source of the fluid and the first pressure detector after the fluid having the set flow rate is caused to flow by opening the diaphragm, and acquiring the reference data measured while the valve is closed, and the target measurement step may be a step of closing the valve after the fluid having the set flow rate is caused to flow by opening the diaphragm, and measuring the target data while the valve is closed. In a case where the valve provided between the supply source of the fluid and the diaphragm valve is closed after the fluid having the set flow rate is caused to flow, the fluid flows out from a flow path, so that the pressure in the flow path gradually decreases. A method of measuring the flow rate of the fluid in the flow path at a predetermined pressure by using this process is called a build-down method. The first pressure is gradually reduced by performing the build-down method once in each of the reference acquisition step and the target acquisition step, whereby a plurality of combinations of the first pressure and the control value of the piezoelectric element corresponding to the first pressure can be measured. In this way, this inspection method for the flow rate controller can carry out an efficient inspection.

In an embodiment, in the inspection method, the reference acquisition step may use a first fluid as the fluid, the target measurement step may use a second fluid as the fluid, and the determination step may further include an application step of applying, to the reference data of the first fluid, a flow factor for converting into the reference data of the second fluid, and comparing the reference data of the second fluid with the target data of the second fluid. There is a case where while the reference data in the first fluid is acquired in the reference acquisition step, the target data in the second fluid is measured in the target acquisition step. In this case, the determination step includes the application step, whereby it is possible to inspect the reference data of the second fluid and the target data of the second fluid by using the flow factor for converting the reference data of the first fluid into the reference data of the second fluid. Accordingly, in this inspection method for the flow rate controller, it is possible to easily obtain the inspection result of the control function of the flow rate controller in a different type of fluid from the fluid applied to the flow rate controller.

In an embodiment, in the inspection method, the flow rate controller may further include an orifice which is provided downstream of the diaphragm valve in the flow path and controls the supply amount of the fluid flowing to the downstream of the flow path by the diaphragm valve, a second pressure detector which is provided between the diaphragm valve and the orifice in the flow path and detects a second pressure that is a pressure of the fluid, and a third pressure detector which is provided downstream of the orifice in the flow path and detects a third pressure that is a pressure of the fluid. In this case, the amount of the fluid flowing out at the downstream of the orifice is controlled by the orifice. Due to the control of the orifice, the second pressure which is measured at the second pressure detector is hardly affected by the third pressure which is measured at the third pressure detector downstream of the orifice. Accordingly, it is possible to stably calculate the flow rate in the vicinity of the second pressure detector, which is derived from the second pressure.

In another aspect, a flow rate controller is provided. The flow rate controller is a flow rate controller for controlling a flow rate of a fluid and inspecting a function related to the control, and includes a first pressure detector for detecting a first pressure that is a pressure of the fluid, a diaphragm valve provided downstream of the first pressure detector and having a diaphragm and a piezoelectric element for driving the diaphragm, and a control unit connected to the first pressure detector and the diaphragm valve, in which the control unit executes a reference acquisition step of acquiring reference data including a first pressure and a control value of the piezoelectric element with respect to a set flow rate of the fluid, a target measurement step of measuring target data including the first pressure and the control value of the piezoelectric element with respect to the set flow rate of the fluid after execution of the reference acquisition step, and a determination step of determining whether or not there is a problem in the diaphragm valve, by comparing the reference data with the target data.

According to this flow rate controller, the fluid having the set flow rate flows through the flow path passing through the flow rate controller in the order of the first pressure detector and the diaphragm valve. The first pressure of the fluid is measured by the first pressure detector. The control value of the piezoelectric element is measured by the diaphragm valve. In the control unit, in the reference acquisition step, the reference data including the first pressure and the control value of the piezoelectric element with respect to the set flow rate of the fluid is acquired. In the acquisition of the reference data, the control unit may acquire the reference data by reading the reference data already recorded from an external recording device, or may acquire the reference data by measuring the reference data. In the control unit, in the target acquisition step, the target data including the first pressure and the control value of the piezoelectric element with respect to the set flow rate of the fluid is measured. In the control unit, in the determination step, the reference data is compared with the target data. Since the old and new first pressures acquired under the common setting condition in the same flow rate controller can be compared with the control value of the piezoelectric element, it is possible to perform the inspection regardless of the individual difference of the flow rate controller. By this inspection, it is possible to always monitor the abnormality or specular change of the diaphragm valve which occurs according to a use period, a use frequency, a use environment, or the like, at the time of maintenance. Accordingly, in this flow rate controller, it is possible to inspect the control function of the flow rate controller regardless of the individual difference of the flow rate controller.

Hereinafter, various embodiments will be described in detail with reference to the drawings. In the following description and each drawing, identical or equivalent elements are denoted by the same reference numerals, and overlapping description is not repeated. The dimensional ratios in the drawings do not necessarily coincide with those in the description. The terms “top”, “bottom”, “left”, and “right” are based on the illustrated state and are for convenience.

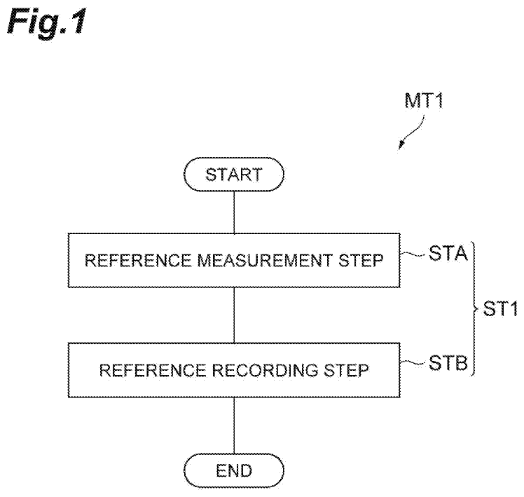

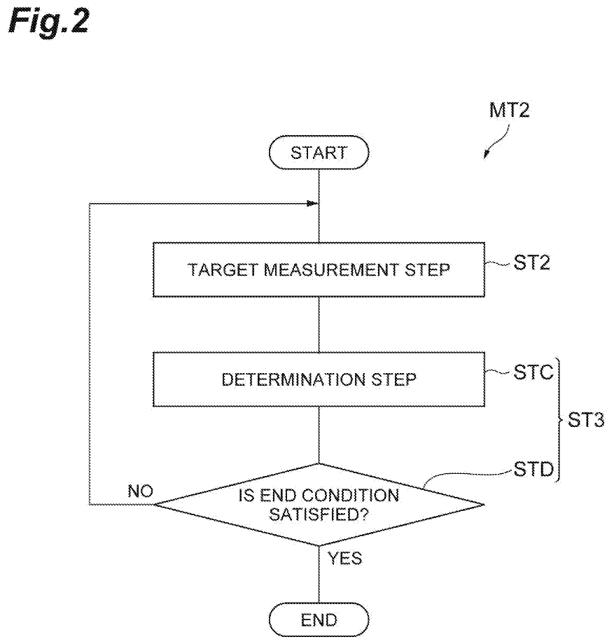

FIG. 1 is a flowchart illustrating an example of the reference acquisition step of the inspection method for the flow rate controller according to an embodiment. FIG. 2 is a flowchart illustrating an example of the target measurement step and the determination step of the inspection method for the flow rate controller according to the embodiment. An inspection method MT1 illustrated in FIG. 1 and an inspection method MT2 illustrated in FIG. 2 are methods of inspecting the flow rate control function of a flow rate controller FC in a fluid supply system 1. In the inspection of the flow rate control function of the flow rate controller FC, the inspection method MT1 and the inspection method MT2 are executed in order.

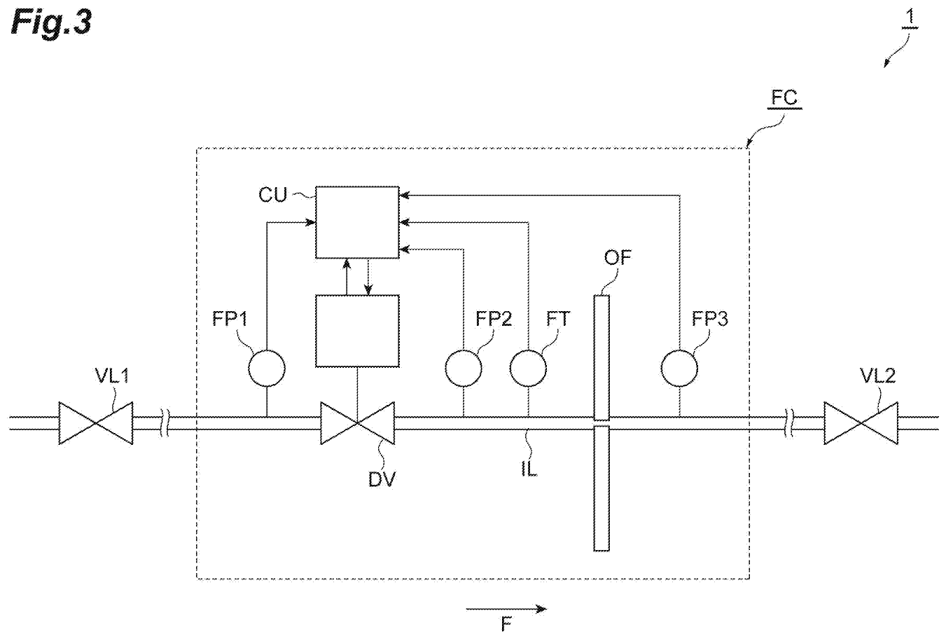

FIG. 3 is a schematic diagram illustrating an example of the fluid supply system which includes the flow rate controller according to the embodiment. The fluid supply system 1 illustrated in FIG. 3 can include a flow path IL, a first valve VL1, the flow rate controller FC, and a second valve VL2. The flow path IL extends in both the upstream and downstream directions with the flow rate controller FC as a reference. The flow path IL is formed in a gas pipe made of stainless steel, for example. The flow path IL is connected to a supply source of the fluid on the upstream side. The flow path IL allows the fluid to flow in the direction of an arrow F. The fluid is, for example, a gas such as nitrogen or argon, or a liquid such as water.

The first valve VL1 is connected to the upstream of the flow rate controller FC in the flow path IL. The second valve VL2 is connected to the downstream of the flow rate controller FC in the flow path IL. The first valve VL1 and the second valve VL2 are opened or closed to permit or block the flow of the fluid to the downstream.

The flow rate controller FC controls the flow rate of the fluid flowing through the flow path IL from the upstream to the downstream. The flow rate controller FC includes a first pressure detector FP1 and a diaphragm valve DV. The flow rate controller FC can include an orifice OF, a second pressure detector FP2, a third pressure detector FP3, a temperature detector FT, and a control unit CU. In the flow rate controller FC, the first pressure detector FP1, the diaphragm valve DV, the second pressure detector FP2, the temperature detector FT, the orifice OF, and the third pressure detector FP3 are provided in order from the upstream side toward the downstream side on the flow path IL.

The first pressure detector FP1 measures a first pressure, which is the pressure in the flow path IL, on the upstream side of the diaphragm valve DV. The second pressure detector FP2 measures a second pressure, which is the pressure in the flow path IL, between the diaphragm valve DV and the orifice OF. The third pressure detector measures a third pressure, which is the pressure in the flow path IL, on the downstream side of the orifice OF. The first pressure detector FP1, the second pressure detector FP2, and the third pressure detector FP3 are, for example, pressure transducers. Each of the first pressure detector FP1, the second pressure detector FP2, and the third pressure detector FP3 outputs information on the pressure value obtained by detecting the pressure of the fluid flowing through the flow path IL by the control of the control unit CU, to the control unit CU.

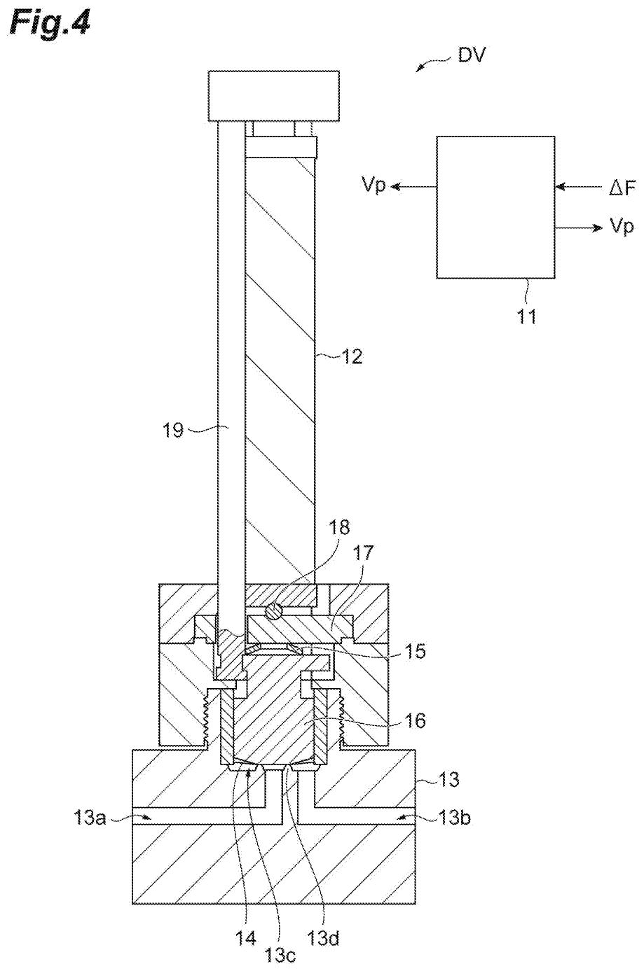

The diaphragm valve DV is provided on the flow path IL between the first pressure detector FP1 and the second pressure detector FP2. FIG. 4 is a diagram illustrating an example of the configuration of the diaphragm valve according to an embodiment. The diaphragm valve DV illustrated in FIG. 4 can include a control circuit 11, a piezoelectric element 12 (a piezo element), a main body 13, a diaphragm 14, a disk spring 15, a hold-down member 16, a base member 17, a spherical body 18, and a support member 19.

A flow rate difference ΔF between an output flow rate and a set flow rate is input from the control unit CU to the control circuit 11. The output flow rate is a flow rate downstream of the orifice OF, which is calculated based on the second pressure measured in the second pressure detector FP2. The set flow rate is a flow rate (a target flow rate) set by the control unit CU and caused to flow through the flow rate controller FC. The control circuit 11 controls an applied voltage Vp that is a voltage which is applied to the piezoelectric element 12, such that the flow rate difference ΔF becomes zero, for example. The control circuit 11 inputs a signal that specifies the applied voltage Vp to the piezoelectric element 12 to the control unit CU. That is, the control unit CU acquires a signal (a control value of the diaphragm valve DV) that specifies the applied voltage Vp to the piezoelectric element 12.

The piezoelectric element 12 drives the diaphragm 14 in an opening and closing operation of the diaphragm valve DV. The piezoelectric element 12 extends in response to the applied voltage Vp that is an example of a control voltage controlled by the control circuit 11, and performs the opening and closing of the diaphragm valve DV by causing the diaphragm 14 to come close to or be separated from a valve seat 13d (described later).

The main body 13 has a flow path 13a, a flow path 13b, a valve chamber 13c, and the valve seat 13d. The flow path 13a and the flow path 13b configure a part of the flow path IL described above. The diaphragm 14 is biased to the valve seat 13d by the disk spring 15 through the hold-down member 16. In a case where the applied voltage Vp to the piezoelectric element 12 is zero, the diaphragm 14 is in contact with the valve seat 13d and the diaphragm valve DV is in a closed state.

One end (in the drawing, a lower end) of the piezoelectric element 12 is supported by the base member 17. The piezoelectric element 12 is connected to the support member 19. The support member 19 is coupled to the hold-down member 16 at one end (in the drawing, a lower end) thereof. If the applied voltage Vp is applied to the piezoelectric element 12, the piezoelectric element 12 extends. If the piezoelectric element 12 extends, the support member 19 moves in the direction away from the valve seat 13d, and accordingly, the hold-down member 16 also moves in the direction away from the valve seat 13d. In this way, the diaphragm 14 is separated from the valve seat 13d, so that the diaphragm valve DV enters an opened state. The degree of opening of the diaphragm valve DV, that is, the distance between the diaphragm 14 and the valve seat 13d is controlled by the applied voltage Vp which is applied to the piezoelectric element 12, which is a control value of the piezoelectric element 12.

FIG. 3 is referred to again. The orifice OF partially reduces the cross-sectional area of the flow path IL in the flow path IL between the second pressure detector FP2 and the third pressure detector FP3. In the flow rate controller FC, in a case where the second pressure upstream of the orifice OF is two or more times the third pressure downstream of the orifice OF, the degree of opening of the diaphragm valve DV is controlled by the control unit CU so as to reduce the difference between the output flow rate and the set flow rate. In this case, the third pressure is not used, and the flow rate in the flow path IL is calculated based on the second pressure. In a case where the second pressure is smaller than twice the third pressure, the degree of opening of the diaphragm valve DV is controlled by the control unit CU so as to reduce the difference between the flow rate which is required from the difference between the second pressure and the third pressure and the set flow rate. The flow rate controller FC may not include the third pressure detector FP3 in a case of being used in a state where the second pressure is two or more times the third pressure.

The temperature detector FT is configured to measure the temperature in the flow path IL. By using the first pressure or the second pressure and the temperature, it is possible to calculate the flow rate upstream or downstream of the diaphragm valve DV in the control unit CU.

The control unit CU can be configured with a control device (a control board) composed of a microcomputer provided with a CPU. The hardware of the control unit CU can be configured with a circuit (control) board equipped with a central processing unit (CPU), a read only memory (ROM), a random access memory (RAM), an A/D conversion circuit, a D/A conversion circuit, and a communication I/F (interface) circuit. The CPU, the ROM, the RANI, the A/D conversion circuit, the D/A conversion circuit, and the communication I/F circuit are connected to a bus line. The A/D conversion circuit and the D/A conversion circuit are connected to the bus line through an input/output I/F circuit.

The CPU is a central arithmetic unit for analyzing a program stored in the ROM and controlling the operation of the flow rate controller FC. The CPU is, for example, a high-speed CPU composed of 32 bits or the like. The ROM stores a program for controlling the operation of the flow rate controller FC. As the ROM, for example, an EPROM (Erasable Programmable Read Only Memory) or a flash memory is used.

The RAM is storage means (a memory) for causing the program stored in the ROM to store in advance a calculation area (work area) and the output flow rate, the set flow rate, the first pressure, the second pressure, the third pressure, the applied voltage Vp to the piezoelectric element, and the like, for controlling the operation of the flow rate controller FC. The RAM may be made such that high-speed processing of a program is executed by using a CPU built-in RAM built in the CPU.

The first pressure detector FP1, the second pressure detector FP2, the third pressure detector FP3, the temperature detector FT, the control circuit 11, and the like are connected to the A/D conversion circuit. Further, the control circuit 11 is connected to the D/A conversion circuit, and the applied voltage Vp adjusted by the control circuit 11 is applied to the piezoelectric, element 12.

The communication I/F circuit is an I/F circuit for performing data communication with an external device, and for example, a high-order host computer is connected to the communication I/F circuit. Further, for example, a monitor device which is configured with a personal computer or the like is connected to the communication I/F circuit. The monitor device is a device which is connected and used as necessary, for example, in a case of monitoring information on the output flow rate, the set flow rate, the first pressure, the second pressure, the third pressure, the applied voltage Vp to the piezoelectric element, and the like, or the like.

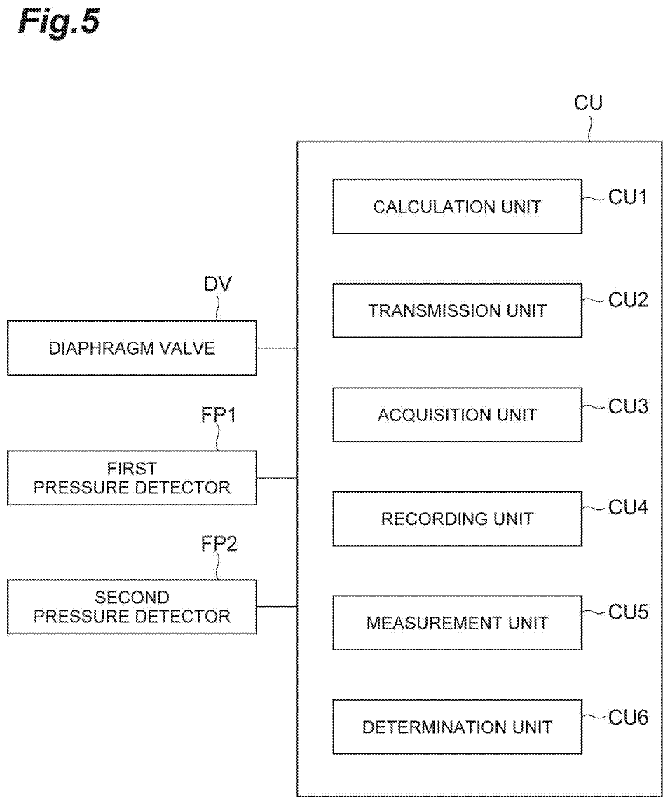

FIG. 5 is a block diagram illustrating an example of a function of the inspection method for the flow rate controller according to an embodiment. The control unit CU can include a calculation unit CU1, a transmission unit CU2, an acquisition unit CU3, a recording unit CU4, a measurement unit CU5, and a determination unit CU6. The control unit CU is connected to the diaphragm valve DV and the first pressure detector FP1. The calculation unit CU1 calculates the output flow rate, based on the second pressure and the temperature in the temperature detector FT. The calculation unit CU1 calculates the flow rate difference ΔF that is the difference between the output flow rate and the set flow rate. The calculation unit CU1 applies a flow factor (described later) to the reference data. The transmission unit CU2 transmits the flow rate difference ΔF calculated in the calculation unit CU1 to the control circuit 11 as a signal.

The acquisition unit CU3 acquires the reference data which includes the first pressure in the first pressure detector FP1 and the control value of the piezoelectric element in the diaphragm valve DV from an external recording device in a reference acquisition step (ST1) (described later). The recording unit CU4 records the output flow rate, the set flow rate, the first pressure, the second pressure, the third pressure, the applied voltage Vp to the piezoelectric element, and the like, which are for controlling the operation of the flow rate controller FC. The measurement unit CU5 measures the reference data in a reference measurement step (STA) (described later) in a case where there is no reference data acquisition in the acquisition unit CU3. The measurement unit CU5 measures the target data which includes the first pressure in the first pressure detector FP1 and the control value of the piezoelectric element in the diaphragm valve DV in a target measurement step (ST2) (described later). The determination unit CU6 compares the reference data with the target data and inspects the flow rate control function of the flow rate controller FC, in a determination step (ST3) (described later).

(Inspection Method for Flow Rate Controller)

Hereinafter, the inspection method MT1 will be described with reference to FIG. 1 again. The inspection method MT1 is executed in the control unit CU. In the reference acquisition step (ST1), the first pressure and the control value of the piezoelectric element are acquired as the reference data in the acquisition unit CU3 of the control unit CU. In the present embodiment, the control value of the piezoelectric element is the applied voltage Vp. The reference acquisition step (ST1) can include the reference measurement step (STA) and a reference recording step (STB). In the reference acquisition step (ST1), the reference data may be acquired by reading the reference data already recorded from an external recording device by the acquisition unit CU3, or may be acquired by measuring the reference data by the measurement unit CU5. The acquisition by the measurement of the reference data by the measurement unit CU5 is executed by the reference measurement step (STA) and the reference recording step (STB). Hereinafter, the reference measurement step (STA) and the reference recording step (STB) in the measurement unit CU5 will be described.

The reference measurement step (STA) is executed, for example, at the time of installation of the flow rate controller FC or in an early stage of the beginning of use of the flow rate controller FC. In the reference measurement step (STA), the fluid set to the maximum flow rate flows through the flow path IL in the flow rate controller FC. The maximum flow rate is the maximum flow rate among the flow rates that can flow under the control by the flow rate controller FC. In this case, the degree of opening is adjusted in the diaphragm valve DV. Further, the first valve VL1 and the second valve VL2 are opened. Subsequently, the applied voltage Vp to the piezoelectric element 12 is controlled by the calculation unit CUL the transmission unit CU2, and the control circuit 11. That is, the degree of opening of the diaphragm valve DV is adjusted. For example, in the diaphragm valve DV, the degree of opening is adjusted such that the set flow rate becomes 5% of the maximum flow rate. Thereafter, the calculation unit CUL the transmission unit CU2, the control circuit 11, and the diaphragm valve DV control the applied voltage Vp such that the flow rate difference ΔF between the output flow rate and the set flow rate becomes zero.

Subsequently, in a case where the fluid has flowed to the third pressure detector FP3, the first valve VL1 is closed. In this case, the fluid remaining at the downstream flows through the flow path IL from the first valve VL1. The first valve VL1 is closed and the flow rate is fixed by the diaphragm valve DV and the orifice OF, whereby the first pressure gradually decreases during the inspection method MT1. The processing so far is called a build-down method.

Subsequently, in a case where the first pressure has reached a k-th threshold value, the reference data is measured in the first pressure detector FP1 and the diaphragm valve DV by the measurement unit CU5. That is, the first pressure is measured in the first pressure detector FP1, and the applied voltage Vp is measured in the diaphragm valve DV. k is an integer of 1 or more. The k-th threshold value is a pressure value necessary for comparing the reference data with the target data in the determination unit CU6.

The first pressure gradually decreases, and therefore, in the reference measurement step (STA), thereafter, the reference data is measured until the first pressure reaches an n-th threshold value. n is set to a value sufficient to inspect the flow rate control function of the flow rate controller FC in the determination step. n is an integer of 2 or more. n is the upper limit of k. Since the first pressure gradually decreases and the applied pressure Vp is controlled such that the flow rate difference ΔF between the output flow rate and the set flow rate becomes 0, the applied voltage Vp and the degree of opening of the diaphragm valve DV gradually increase.

In the reference recording step (STB), the reference data that is measured in the reference measurement step (STA) and is a combination of the first pressure and the applied voltage Vp is stored in the recording unit CU4. In the reference measurement step (STA), the reference recording step (STB) may be executed each time the first pressure reaches the k-th threshold value and the reference data is measured by the measurement unit CU5. In this case, the reference recording step (STB) can be executed during the reference measurement step (STA). After all the reference data until the first pressure reaches from the first threshold value to the n-th threshold value is measured by the measurement unit CU5 in the reference measurement step (STA), the reference data may be recorded at once from the measurement unit CU5 to the recording unit CU4 in the reference recording step (S′IB). In a case where all the reference data measured in the reference measurement step (STA) are recorded in the reference recording step (STB), the inspection method MT1 is ended.

Hereinafter, the inspection method MT2 will be described with reference to FIG. 2 again. The inspection method MT2 is executed in the control unit CU. In the target measurement step (ST2), the target data which includes the first pressure and the control value of the piezoelectric element is measured by the measurement unit CU5. The measurement method in the target measurement step (ST2) is the same as that in the reference measurement step (STA). In the target measurement step (ST2), in a case where the first pressure has reached the k-th threshold value, the target data is measured by the measurement unit CU5.

The determination step (ST3) may be started during the target measurement step (ST2) in a case where one target data is measured in the target measurement step (ST2). The determination step (ST3) may include the comparison and determination step (STC) and an end determination step (STD). In the comparison and determination step (STC), the reference data is compared with the target data by the determination unit CU6. In the comparison and determination step (STC), the determination unit CU6 determines whether or not the applied voltage Vp in the target data falls within the range of a reference width from the applied voltage Vp in the reference data. The reference width can be determined in consideration of variation in communication, variation in reproducibility of the piezoelectric element 12 itself, or the like.

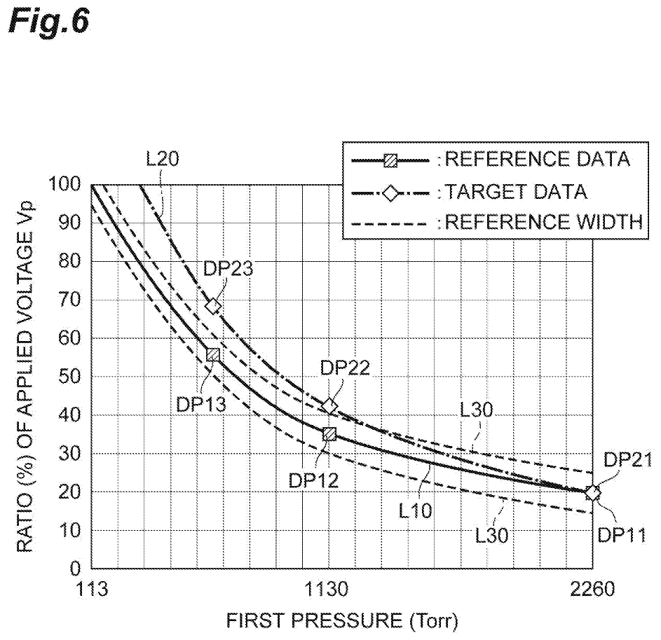

FIG. 6 is a graph illustrating an example of the relationship between the reference data and the target data in the determination step of the inspection method for the flow rate controller according to the embodiment. The horizontal axis of FIG. 6 is the first pressure (Torr), and the vertical axis is the ratio (%) of the measured applied voltage Vp to the applied voltage Vp to the piezoelectric element in a case where the degree of opening of the diaphragm valve DV is 100%. In FIG. 6, a reference data line L10, a target data line L20, and a reference width line L30 are drawn. The reference data line L10 is, for example, a curve which is estimated from the reference data obtained from the first threshold value to the n-th threshold value. The target data line L20 is, for example, a curve which is estimated from the target data obtained from the first threshold value to the n-th threshold value. The reference width line L30 is a curve obtained by adding or subtracting the reference data line L10 by the reference width determined for each first pressure.

As an example of the result of the reference data in a case where the first pressure is an s-th threshold value, a t-th threshold value, and a u-th threshold value, a data point DP11, a data point DP12, and a data point DP13 are plotted on the reference data line L10. Each of s, t, and u is an integer of 1 or more. As an example of the result of the target data in a case where the first pressure is the s-th threshold value, the t-th threshold value, and the u-th threshold value, a data point DP21, a data point DP22, and a data point DP23 are plotted on the target data line L20.

For example, the data point DP21 falls within the range of the reference width centered on the data point DP11. In this way, in a case where the first pressure is the s-th threshold value, it is determined that there is no problem in the flow rate control function of the flow rate controller FC. For example, the data point DP22 does not fall within the range of the reference width centered on the data point DP12. The data point DP23 does not fall within the range of the reference width centered on the data point DP13. In this way, in a case where the first pressure is the t-th threshold value and the u-th threshold value, it is determined that there is a problem in the flow rate control function of the flow rate controller FC.

In a case where the target data line L20 is drawn between the two reference width lines L30, it is determined that there is no problem in the flow rate control function of the flow rate controller FC. In a case where there is a portion where the target data line L20 is not drawn between the two reference width lines L30, it is determined that there is a problem in the flow rate control function of the flow rate controller FC. The determination result obtained by the determination unit CU6 may be recorded in the recording unit CU4. The determination result obtained by the determination unit CU6 may be displayed on the monitor device.

Subsequently, in the determination step (ST3), after the determination in the comparison and determination step (STC), the routine proceeds to the end determination step (STD). In the end determination step (STD), whether or not all the combinations of the reference data and the target data have been compared is determined by the determination unit CU6. Since the applied voltages Vp with respect to n first pressures are inspected, in a case where all the combinations have not been inspected, in the end determination step (STD), the routine proceeds to the target measurement step (ST2) again. In a case where all the combinations have been inspected, the inspection method MT2 is ended in the end determination step (STD). The determination step (ST3) may be started after all the target data are measured in the target measurement step (ST2). In that case, the end determination step (STD) may not be provided.

(Application of Flow Factor)

In a case where the fluid of the reference data acquired in the reference acquisition step (ST1) is a first fluid and the fluid of the target data measured in the target measurement step (ST2) is a second fluid, the determination step (ST3) can have an application step. The first fluid and the second fluid are different types of fluids. The application step is performed before the comparison and determination step (STC). In the application step, the flow factor for converting into the reference data of the second fluid is applied to the reference data of the first fluid by the calculation unit CU1. The flow factor can be a numerical value representing a change in flow rate display according to the type of the second fluid with respect to the first fluid. The flow factor includes characteristic values such as density, a specific heat ratio, and a gas constant corresponding to the first fluid and the second fluid. As an example, the flow factor may be a coefficient which is defined by the international standard IEC60534-1 (corresponding to Japanese Industrial Standard JIS B 2005-1). The flow factor may be a value determined such that the flow rate of an orifice in which the flow rate of water at 60° F. flows at 1 gallon/min in one minute with a pressure difference of 1 psi becomes 1. In a case of adopting gas, the definition may be made by replacing water with air.

By the application of the flow factor in the application step, the flow rate and the first pressure of the second fluid upstream of the diaphragm valve DV are calculated based on the first pressure of the first fluid, and the reference data of the second fluid is obtained. After the flow factor is applied in the calculation unit CM in the application step, as the comparison and determination step (STC), the comparison and inspection between the reference data of the second fluid and the target data of the second fluid are performed by the determination unit CU6. In a case where the target data falls within the range of the reference width from the reference data, it is determined that there is no problem in the flow rate control function for the second fluid of the flow rate controller FC. In a case where the target data does not fall within the range of the reference width from the reference data, it is determined that there is a problem in the flow rate control function for the second fluid of the flow rate controller FC.

### Effects

As described above, according to the inspection method for the flow rate controller FC and the flow rate controller FC of the present embodiment, it is possible to inspect the flow rate control function of the flow rate controller. Further, by the reference acquisition step (ST1), the target measurement step (ST2), and the determination step (ST3), the new and old first pressures can be compared with the control value of the piezoelectric element under the common setting condition in the same flow rate controller FC. That is, it is possible to perform the inspection regardless of the individual difference of the flow rate controller FC. By this inspection, it is possible to always monitor the abnormality or specular change of the diaphragm valve DV which occurs according to a use period, a use frequency, a use environment, or the like, at the time of maintenance. Even in a case where there is no reference data already recorded, the reference measurement step (STA) and the reference recording step (STB) are provided, whereby it is possible to perform the comparison by using the reference data in the determination step (ST3).

The build-down method is carried out once in each of the reference acquisition step (ST1) and the target acquisition step (ST2), whereby the first pressure gradually decreases, so that a plurality of combinations of the first pressure and the control value of the piezoelectric element corresponding to the first pressure can be measured. The determination step (ST3) includes the application step, whereby it is possible to inspect the reference data of the second fluid and the target data of the second fluid by using the flow factor for converting the reference data of the first fluid into the reference data of the second fluid. By the control of the orifice, the second pressure which is measured at the second pressure detector is hardly affected by the third pressure which is measured at the third pressure detector downstream of the orifice. Accordingly, it is possible to stably calculate the flow rate in the vicinity of the second pressure detector, which is derived from the second pressure.

Although various exemplary embodiments have been described above, the present disclosure is not limited to the exemplary embodiments described above, and various omissions, substitutions, and changes may be made. Further, it is possible to combine the elements in different embodiments to form other embodiments. For example, the flow rate controller FC may not include the orifice OF, the second pressure detector FP2, and the third pressure detector FP3. In this case, for example, the flow rate downstream of the diaphragm valve DV may be measured outside the flow rate controller FC. The applied voltage Vp may be controlled using the flow rate downstream of the diaphragm valve DV measured outside.

In the measurement method in the reference measurement step (STA) or the target measurement step (ST2), the calculation unit CUL the transmission unit CU2, the control circuit 11, and the diaphragm valve DV may change the set flow rate according to the measurement time. In a case where the set flow rate is set large, the measurement time of the reference measurement step (STA) or the target measurement step (ST2) becomes short. In a case where the set flow rate is set small, the measurement time of the reference measurement step (STA) or the target measurement step (ST2) becomes long.

In a case where the set flow rate is set large, the applied voltage Vp is controlled to be large. During the measurement of the reference data or the target data, the applied voltage Vp is controlled so as to increase gradually, and therefore, the reference data or the target data of the applied voltage Vp larger than the applied voltage Vp in a case where the first pressure is the first threshold value is obtained. On the other hand, the set flow rate is set small, whereby it becomes possible to inspect the flow rate controller FC in a case where the applied voltage Vp is close to 0 and the value is small.

From the above description, it will be understood that various embodiments of the present disclosure have been described in this specification for purposes of description and that various modifications can be made without departing from the scope and gist of the present disclosure. Therefore, the various embodiments disclosed in this specification are not intended to limit the present disclosure, and the true scope and gist are shown by the appended claims.

What is claimed is:

1. A method of inspecting a flow rate controller for controlling a flow rate of a fluid,
the flow rate controller including
a first pressure detector configured to detect a first pressure that is a pressure of the fluid, and
a diaphragm valve provided downstream of the first pressure detector and having a diaphragm and a piezoelectric element for driving the diaphragm,
the method comprising:
acquiring reference data including the first pressure and a control value of the piezoelectric element with respect to a set flow rate of the fluid;
measuring target data including the first pressure and the control value of the piezoelectric element with respect to the set flow rate of the fluid after execution of the acquiring; and
determining whether or not there is a problem in the diaphragm valve, by comparing the reference data with the target data.

2. The method according to claim 1, wherein the acquiring includes measuring the reference data, and recording the reference data.

3. The method according to claim 1, wherein the acquiring is a step of closing a valve provided between a supply source of the fluid and the first pressure detector after the fluid having the set flow rate is caused to flow by opening the diaphragm, and acquiring the reference data measured while the valve is closed, and
the measuring is a step of closing the valve after the fluid having the set flow rate is caused to flow by opening the diaphragm, and measuring the target data while the valve is closed.

4. The method according to claim 2, wherein the acquiring is a step of closing a valve provided between a supply source of the fluid and the first pressure detector after the fluid having the set flow rate is caused to flow by opening the diaphragm, and acquiring the reference data measured while the valve is closed, and
the measuring is a step of closing the valve after the fluid having the set flow rate is caused to flow by opening the diaphragm, and measuring the target data while the valve is closed.

5. The method according to claim 1, wherein the acquiring uses a first fluid as the fluid, the measuring uses a second fluid as the fluid, and
the determining further includes applying, to the reference data of the first fluid, a flow factor for converting into the reference data of the second fluid, and comparing the reference data of the second fluid with the target data of the second fluid.

6. The method according to claim 2, wherein the acquiring uses a first fluid as the fluid, the measuring uses a second fluid as the fluid, and
the determining further includes applying, to the reference data of the first fluid, a flow factor for converting into the reference data of the second fluid, and comparing the reference data of the second fluid with the target data of the second fluid.

7. The method according to claim 3, wherein the acquiring uses a first fluid as the fluid, the measuring uses a second fluid as the fluid, and
the determining further includes applying, to the reference data of the first fluid, a flow factor for converting into the reference data of the second fluid, and comparing the reference data of the second fluid with the target data of the second fluid.

8. The method according to claim 4, wherein the acquiring uses a first fluid as the fluid, the measuring uses a second fluid as the fluid, and
the determining further includes applying, to the reference data of the first fluid, a flow factor for converting into the reference data of the second fluid, and comparing the reference data of the second fluid with the target data of the second fluid.

9. The method according to claim 1, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

10. The method according to claim 2, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

11. The method according to claim 3, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

12. The method according to claim 4, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

13. The method according to claim 5, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

14. The method according to claim 6, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

15. The method according to claim 7, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

16. The method according to claim 8, wherein the flow rate controller further includes
an orifice provided downstream of the diaphragm valve and controlling a supply amount of the fluid,
a second pressure detector provided between the diaphragm valve and the orifice and configured to detect a second pressure that is a pressure of the fluid, and
a third pressure detector provided downstream of the orifice and configured to detect a third pressure that is a pressure of the fluid.

17. A flow rate controller for controlling a flow rate of a fluid and inspecting a function related to the control, comprising:
a first pressure detector configured to detect a first pressure that is a pressure of the fluid;
a diaphragm valve provided downstream of the first pressure detector and having a diaphragm and a piezoelectric element for driving the diaphragm, and
a control unit connected to the first pressure detector and the diaphragm valve,
wherein the control unit executes
acquiring reference data including a first pressure and a control value of the piezoelectric element with respect to a set flow rate of the fluid,
measuring target data including the first pressure and the control value of the piezoelectric element with respect to the set flow rate of the fluid after execution of the acquiring, and
determining whether or not there is a problem in the diaphragm valve, by comparing the reference data with the target data.
